(19) United States
(12) Patent Application Publication
(10) Pub. No.: US 2024/0172206 A1
(43) Pub. Date: May 23, 2024

(54) METHOD FOR IMPLICITLY SIGNALING TRANSMIT SWITCHING CONFIGURATION OF MULTIPLE OPERATING BANDS AND ASSOCIATED WIRELESS COMMUNICATION DEVICE

(71) Applicant: MEDIATEK INC., Hsin-Chu (TW)

(72) Inventors: Huan-Ren Fu, Hsinchu City (TW); Aijun Cao, Linkoping (SE); Hsiang-Hui Chang, Hsinchu City (TW)

(73) Assignee: MEDIATEK INC., Hsin-Chu (TW)

(21) Appl. No.: 18/500,123

(22) Filed: Nov. 2, 2023

Related U.S. Application Data
(60) Provisional application No. 63/384,087, filed on Nov. 16, 2022.
(60) Provisional application No. 63/500,925, filed on May 9, 2023.

(51) Int. Cl. H04W 72/0453; H04W 72/21

(52) U.S. Cl. CPC H04W 72/0453; H04W 72/21

(57) ABSTRACT

A method for implicitly signaling a transmit (Tx) switching configuration includes: configuring a first signaling message to indicate a band combination of a plurality of bands; and sending the first signaling message, wherein the Tx switching configuration is implicitly signaled by an order of the plurality of bands of the band combination indicated by the first signaling message.

### CROSS REFERENCE TO RELATED APPLICATIONS

This application claims the benefit of U.S. Provisional Application No. 63/384,087, filed on Nov. 16, 2022. Further, this application claims the benefit of U.S. Provisional Application No. 63/500,925, filed on May 9, 2023. The contents of these applications are incorporated herein by reference.

### BACKGROUND

The present invention relates to wireless communications, and more particularly, to a method for implicitly signaling a transmit (Tx) switching configuration of multiple operating bands and an associated wireless communication device.

The 3rd Generation Partnership Project (3GPP) has been focusing on the uplink enhanced technology in the 5G New Radio (NR) standard. In Release 16, transmit (Tx) switching between two operating bands is introduced and corresponding requirements were specified for the Tx switching between 1Tx and 2Tx for one carrier from each of the two bands. In Release 17, Tx switching was further enhanced by supporting the Tx switching between 2Tx and 2Tx for one carrier from one band, and two contiguous component carriers (CC) from the other band. In Release 18, Tx switching is extended further from two bands to three or four bands, and it is expected that even more bands could be involved. Due to being limited by complexity of the antenna design, a user equipment (UE) generally has only two Tx chains (2Tx) for uplink. However, with the number of operating bands in the Tx switching increased from two to three or more, an ambiguity issue is raised due to the fact that a variety of Tx switching configurations for multiple operating bands are selectable. In order to resolve this ambiguity issue, one conventional solution is proposed that the maximum of switching periods of all possible switching pairs at two Tx chains is applied during the actual Tx switching. Since no data transaction is permitted during a switching period, applying a maximum switching period leads to unnecessary performance loss due to the blanking of an actual switching period that is shorter than the maximum switching period.

### SUMMARY

One of the objectives of the claimed invention is to provide a method for implicitly signaling a transmit (Tx) switching configuration of multiple operating bands and an associated wireless communication device.

According to a first aspect of the present invention, an exemplary method for implicitly signaling a transmit (Tx) switching configuration is disclosed. The exemplary method includes: configuring a first signaling message to indicate a band combination of a plurality of bands; and sending the first signaling message, wherein the Tx switching configuration is implicitly signaled by an order of the plurality of bands of the band combination indicated by the first signaling message.

According to a second aspect of the present invention, an exemplary wireless communication device that supports implicitly signaling of a transmit (Tx) switching configuration is disclosed. The exemplary wireless communication device includes a wireless communication circuit and a control circuit. The control circuit is arranged to configure a first signaling message to indicate a band combination of a plurality of bands, and instruct the wireless communication circuit to send the first signaling message, wherein the Tx switching configuration is implicitly signaled by an order of the plurality of bands of the band combination indicated by the first signaling message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication device according to an embodiment of the present invention.

FIG. 2 shows a case where a band pair before switching is Band A+B, a band pair after switching is Band C+D, a switching pair at Tx Chain #1 is Band A+C, and a switching pair at Tx Chain #2 is Band B+D.

FIG. 3 shows a case where a band pair before switching is Band A+B, a band pair after switching is Band C+D, a switching pair at Tx Chain #1 is Band A+D, and a switching pair at Tx Chain #2 is Band B+C.

FIG. 4 shows a second case where a band pair before switching is Band A+B, a band pair after switching is Band C+D, a switching pair at Tx Chain #1 is Band B+C, and a switching pair at Tx Chain #2 is Band A+D.

FIG. 5 shows a case where a band pair before switching is Band A+B, a band pair after switching is Band C+D, a switching pair at Tx Chain #1 is Band B+D, and a switching pair at Tx Chain #2 is Band A+C.

FIG. 6 is a diagram illustrating an implicit signaling design of a Tx switching configuration according to an embodiment of the present invention.

FIG. 7 is a sequence diagram illustrating interactions between an UE (e.g., 5G terminal) and a network (e.g., gNB of NG-RAN), both supporting the proposed band-ordering approach for implicitly signaling a Tx switching configuration, according to an embodiment of the present invention.

FIG. 8 is a diagram illustrating uplink transmission utilization improvement resulting from the use of a UE-preferred Tx switching configuration.

FIG. 9 is a sequence diagram illustrating interactions between an UE (e.g., 5G terminal) and a network (e.g., gNB of NG-RAN), both supporting the proposed band-ordering approach for implicitly signaling a Tx switching configuration, according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

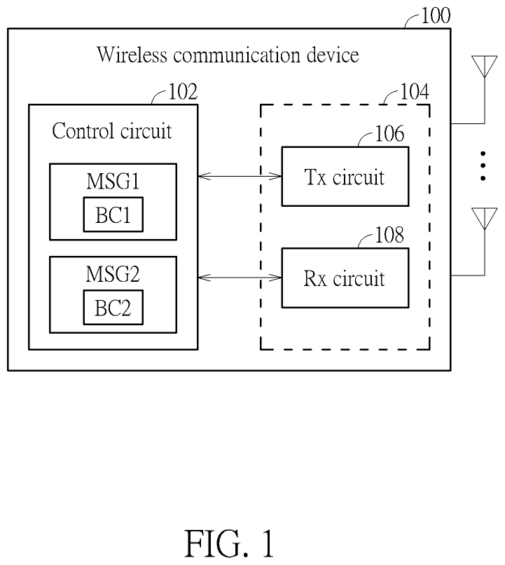

FIG. 1 is a diagram illustrating a wireless communication device according to an embodiment of the present invention. The wireless communication device 100 may operate in a cellular communication system such as a 5G NR cellular communication system. In one embodiment of the present invention, the wireless communication device 102 may be a user equipment (UE) such as a 5G terminal. In another embodiment of the present invention, the wireless communication device 102 may be base station (BS) of a radio access network (RAN) such as a next generation Node-B (gNB) included in a next generation radio access network (NG-RAN). In this embodiment, the wireless communication device 100 supports implicitly signaling of a Tx switching configuration as proposed by the present invention, and may include a control circuit 102 and a wireless communication circuit 104. It should be noted that only the components pertinent to the present invention are illustrated in FIG. 1. In practice, the wireless communication circuit 104 can include additional components to achieve designated functions.

The wireless communication circuit 104 acts as a wireless interface, and includes a Tx circuit 106 and a receive (Rx) circuit 108. The Tx circuit 106 may include more than one Tx chain, and the Rx circuit 108 may include more than one Rx chain. The control circuit 102 may be implemented by a general-purpose processor for realizing the proposed band-ordering approach in a software-based manner, or may be implemented by a dedicated controller for realizing the proposed band-ordering approach in a hardware-based manner. To put it another way, the present invention has no limitations on the implementation of the control circuit 102. The control circuit 102 is arranged to configure a signaling message MSG1 to indicate a band combination BC1 of multiple bands, and instruct the wireless communication circuit 104 (particularly, Tx circuit 106 of wireless communication circuit 104) to send the signaling message MSG1 to another wireless communication device, where the Tx switching configuration is implicitly signaled by an order of multiple bands of the band combination BC1 indicated by the signaling message MSG1. In addition, the wireless communication circuit 104 (particularly, Rx circuit 108 of wireless communication circuit 104) is arranged to receive a signaling message MSG2 from another wireless communication device, and the control circuit 102 is further arranged to obtain the signaling message MSG2 from the wireless communication circuit 104 (particularly, Rx circuit 108 of wireless communication circuit 104), where the signaling message MSG2 indicates a band combination BS2 of multiple bands, and a Tx switching configuration is implicitly signaled by an order of multiple bands in the band combination BS2 indicated by the signaling message MSG2. For example, one of the signaling messages MSG1 and MSG2 may be used to indicate a preferred Tx switching configuration reported by the UE (e.g., 5G terminal), and the other of the signaling messages MSG1 and MSG2 may be a scheduled Tx switching configuration granted by the network (e.g., NG-RAN of 5G system). It should be noted that band-ordering of the band combination BC1 may be identical to or different from band-ordering of the band combination BC2.

In one embodiment of the present invention, the signaling message MSG1/MSG2 may a radio resource management (RRM) message. In another embodiment of the present invention, the signaling message MSG1/MSG2 may be a radio resource control (RRC) message. However, these are for illustrative purposes only, and are not meant to be limitations of the present invention. In practice, any wireless communication device using the proposed band-ordering approach for implicitly signaling a Tx switching configuration falls within the scope of the present invention.

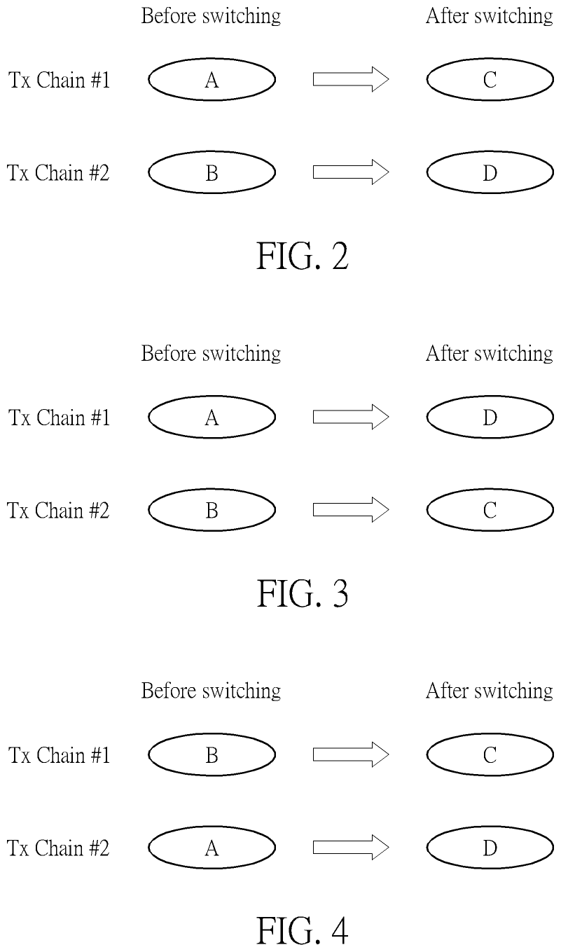

For better comprehension of technical features of the present invention, the following assumes that the UE has only two Tx chains (Tx Chain #1 and Tx Chain #2) for uplink, and supports four bands (Band A, Band B, Band C, Band D) that are involved in Tx switching for uplink performance enhancement. If at a time the UE is operating at Band A+B for its two Tx chains, and the UE is instructed to switch to operate at Band C+D, then there could be four different cases as illustrated in FIGS. 2-5. FIG. 2 shows a case where a band pair before switching is Band A+B, a band pair after switching is Band C+D, a switching pair at Tx Chain #1 is Band A+C, and a switching pair at Tx Chain #2 is Band B+D. In other words, Band A is at Tx Chain #1 before switching, Band B is at Tx Chain #2 before switching, Band C is at Tx Chain #1 after switching, and Band D is at Tx Chain #2 after switching.

FIG. 3 shows a case where a band pair before switching is Band A+B, a band pair after switching is Band C+D, a switching pair at Tx Chain #1 is Band A+D, and a switching pair at Tx Chain #2 is Band B+C. In other words, Band A is at Tx Chain #1 before switching, Band B is at Tx Chain #2 before switching, Band D is at Tx Chain #1 after switching, and Band C is at Tx Chain #2 after switching.

FIG. 4 shows a second case where a band pair before switching is Band A+B, a band pair after switching is Band C+D, a switching pair at Tx Chain #1 is Band B+C, and a switching pair at Tx Chain #2 is Band A+D. In other words, Band B is at Tx Chain #1 before switching, Band A is at Tx Chain #2 before switching, Band C is at Tx Chain #1 after switching, and Band D is at Tx Chain #2 after switching.

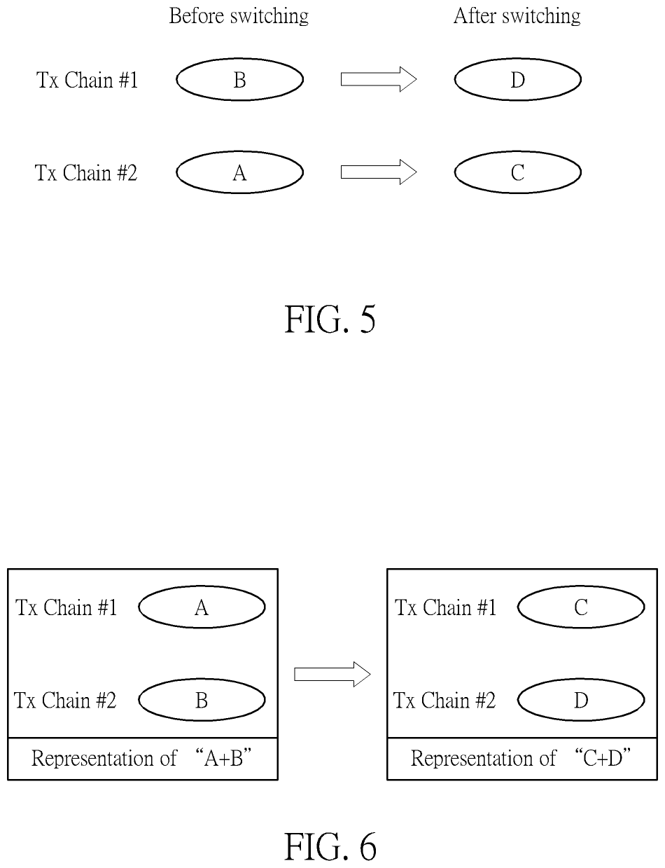

FIG. 5 shows a case where a band pair before switching is Band A+B, a band pair after switching is Band C+D, a switching pair at Tx Chain #1 is Band B+D, and a switching pair at Tx Chain #2 is Band A+C. In other words, Band B is at Tx Chain #1 before switching, Band A is at Tx Chain #2 before switching, Band D is at Tx Chain #1 after switching, and Band C is at Tx Chain #2 after switching.

The above four cases may have different impacts on radio-frequency (RF) requirements, such as four different switching periods including T_{AtoC} (switching period from. Band A to Band C), T_{BtOD} (switching period from. Band B to Band D), T_{AtoD} (switching period from Band A to Band D), and T_{BtoC} (switching period from Band B to Band C). Furthermore, the switching period could be even Tx chain specific. For example, the switching period from Band A to Band C at Tx Chain #1 could be different from that from Band A to Band C at Tx Chain #2. As mentioned in the Background section, one conventional solution applies the maximum of possible switching periods during the actual Tx switching, which leads to unnecessary performance loss due to the blanking of an actual switching period that is shorter than the maximum switching period. To address this issue, the present invention proposes implicitly signaling a Tx switching configuration by an order of bands involved in Tx switching.

The band combination BC1/BC2 specified in the signaling message MSG1/MSG2 has a representation of multiple bands in a specific order. FIG. 6 is a diagram illustrating an implicit signaling design of a Tx switching configuration according to an embodiment of the present invention. In accordance with a representation of a band pair “Band A+B” in the signaling message MSG1/MSG2, the order of bands (Band A, Band B) implicitly indicates that Band A is at Tx Chain #1 and Band B is at Tx Chain #2. Hence, under such representation, an instruction from “A+B” to “C+D” means exactly that at Tx Chain #1, Band A is replaced by Band C, and at Tx Chain #2, Band B is replaced by Band D.

Specifically, an order of multiple bands in a representation of a band combination carried by a signaling message is meaningful and can be used to act as implicitly signaling of a Tx switching configuration. Assuming that the representation of the band combination includes a first band, a second band, a third band and a fourth band, an order of the first band, the second band, the third band and the fourth band may implicitly indicate that the first band and the second band are a band pair before switching, the third band and the fourth band are a band pair after switching, the first band and the third band are a switching pair at a first Tx chain, and the second band and fourth band are a switching pair at a second Tx chain. Since the Tx switching configuration can be implicitly indicated by the order of multiple bands, the ambiguity issue can be resolved without any additional signaling overhead. Furthermore, since the Tx switching configuration can be implicitly indicated by the order of multiple bands, a system performance gain at the UE (e.g., 5G terminal) may be achieved under a condition that a preferred Tx switching confirmation reported by the UE is the same as a scheduled Tx switching confirmation decided by the network (e.g., gNB of NG-RAN) and assigned to the UE (e.g., 5G terminal). For example, an uplink performance at the UE may be enhanced because less blanking in the time domain is required for the Tx switching.

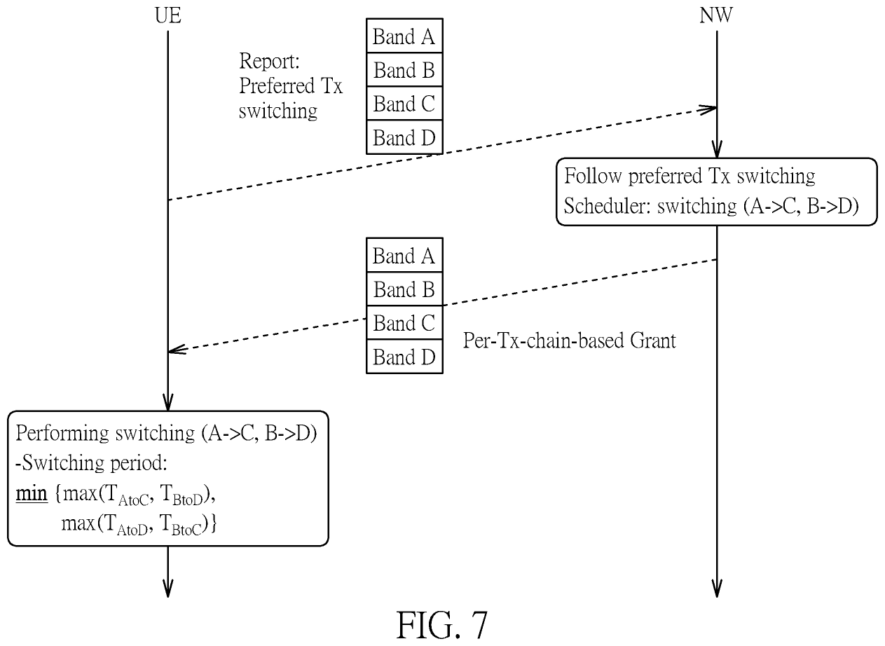

FIG. 7 is a sequence diagram illustrating interactions between an UE (e.g., 5G terminal) and a network NW (e.g., gNB of NG-RAN), both supporting the proposed band-ordering approach for implicitly signaling a Tx switching configuration, according to an embodiment of the present invention. By way of example, but not limitation, each of the UE (e.g., 5G terminal) and the NW (e.g., gNB of NG-RAN) may be implemented using the wireless communication device 100 shown in FIG. 1, where one of the signaling messages MSG1 and MSG2 may be used to indicate a preferred Tx switching configuration reported by the UE, and the other of the signaling messages MSG1 and MSG2 may be a scheduled Tx switching configuration granted by the NW (e.g., NG-RAN of 5G system) and assigned to the UE. The UE may report a preferred Tx switching configuration by the band-ordering approach if the preferred Tx switching configuration has an improved switching period (i.e., a shorter switching period) compared with the base line (e.g., max(T_{AtoC}, T_{BtoD}, T_{AtoD}, T_{BtoC})). Suppose that Band A is at Tx Chain #1 before switching, Band B is at Tx Chain #2 before switching, and the following condition is met:

max(TAtoC,TBtoD)≤max(TAtoC,TBtoD,TAtoD,TBtoC)=max(TAtoD,TBtoC). Hence, the preferred Tx switching configuration for the UE is to replace Band A at Tx Chain #1 with Band C at Tx Chain #1 and replace Band B at Tx Chain #2 with Band D at Tx Chain #2, and the non-preferred Tx switching configuration for the UE is to replace Band A at Tx Chain #1 with Band D at Tx Chain #1 and replace Band B at Tx Chain #2 with Band C at Tx Chain #2. As shown in FIG. 7, the UE reports its preferred Tx switching configuration via “per-Tx-chain-based representation” for band combination (Band A, Band B, Band C, Band D). A code example of UE capability reporting is as follows.
BandCombination-UplinkTxSwitch-v1800::=SEQUENCE {
bandCombination-v1800 BandCombination-v1800
   OPTIONAL,
supportedBandQuadListNR-v1800
SEQUENCE(SIZE(1 . . . maxULTxSwitchingBandQuads)) OF
ULTxSwitchingBandQuad-r18 OPTIONAL,
uplinkTxswitchingWithoutAmbiguity-r18, ENUMERATED,
OPTIONAL,
. . .
}
   ULTxSwitchingBandQuad-r18::=SEQUENCE {
   bandIndexUL1-r18 INTEGER(1 . . . maxSimultaneousBands),
   bandIndexUL2-r18 INTEGER(1 . . . maxSimultaneousBands),
   bandIndexUL3-r18 INTEGER(1 . . . maxSimultaneousBands),
   bandIndexUL4-r18 INTEGER(1 . . . maxSimultaneousBands),
   preferredBandPairsTxChain1
   SEQUENCE(SIZE(1 . . . maxULTxSwitchingBandPairs)) OF
   ULTxSwitchingBandPairPrefer-r18 OPTIONAL,
   preferredBandPairsTxChain2
   SEQUENCE(SIZE(1 . . . maxULTxSwitchingBandPairs)) OF
   ULTxSwitchingBandPairPrefer-r18 OPTIONAL,
   . . .
   }
   ULTxSwitchingBandPairPrefer-r18::={
   bandIndexUL1-switch-from-r18 INTEGER(1 . . . 4),
   bandIndexUL1-switch-to-r18 INTEGER(1 . . . 4),
   uplinkTxSwitchingPeriod-r18 ENUMERATED {nXus, nYus,
   nZus}

The order of bandIndexUL1-r18, bandIndexUL2-r18, bandIndexUL3-r18, bandIndexUL4-r18 implicitly represents the relationship of switch-from and switch-to for each Tx chain. In particular, when NW receives a signaling message reported by UE, the NW interprets the reported Tx switching configuration as:
(1) At Tx Chain #1, switching from bandIndexUL1-r18 to bandIndexUL3-r18; and
(2) At Tx Chain #2, switching from bandIndexUL2-r18 to bandIndexUL4-r18.

In this example, NW schedules an uplink Tx switching as UE's preferred uplink Tx switching, and sends a scheduled Tx switching configuration to UE via “per-Tx-chain-based representation” for band combination (Band A, Band B, Band C, Band D). A code example of network configuration signaling is as follows.
uplinkTxSwitchingBandQuadEnable-r18:=SEQUENCE {
bandIndexUL1-r18 INTEGER(1 . . . maxSimultaneousBands),
bandIndexUL2-r18 INTEGER(1 . . . maxSimultaneousBands),
bandIndexUL3-r18 INTEGER(1 . . . maxSimultaneousBands),
bandIndexUL4-r18 INTEGER(1 . . . maxSimultaneousBands),
   . . .
}

The order of bandIndexUL1-r18, bandIndexUL2-r18, bandIndexUL3-r18, bandIndexUL4-r18 implicitly represents the relationship of switch-from and switch-to for each Tx chain. In particular, when UE receives a signaling message from NW, the UE interprets the scheduled Tx switching configuration as:
(1) At Tx Chain #1, switching from bandIndexUL1-r18 to bandIndexUL3-r18; and
(2) At Tx Chain #2, switching from bandIndexUL2-r18 to bandIndexUL4-r18.

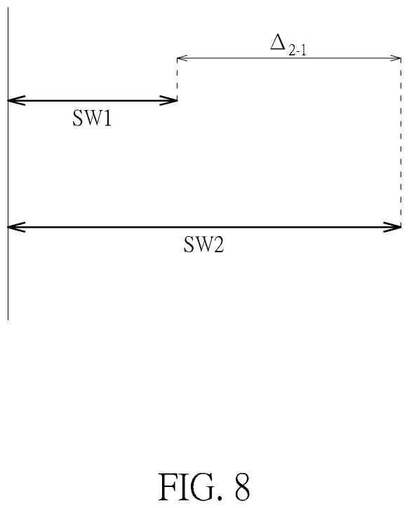

As the preferred Tx switching configuration (which is to replace Band A at Tx Chain #1 with Band C at Tx Chain #1 and replace Band B at Tx Chain #2 with Band D at Tx Chain #2) is granted by the network, a system performance gain can be achieved. FIG. 8 is a diagram illustrating uplink transmission utilization improvement resulting from the use of a UE-preferred Tx switching configuration. Suppose that max(T_{Atoc},T_{BtoD})=SW1, max(T_{AtoD},T_{Btoc})=SW2 and SW2>SW1, the UE-preferred Tx switching configuration can earn Δ₂₋₁ for uplink transmission utilization improvement.

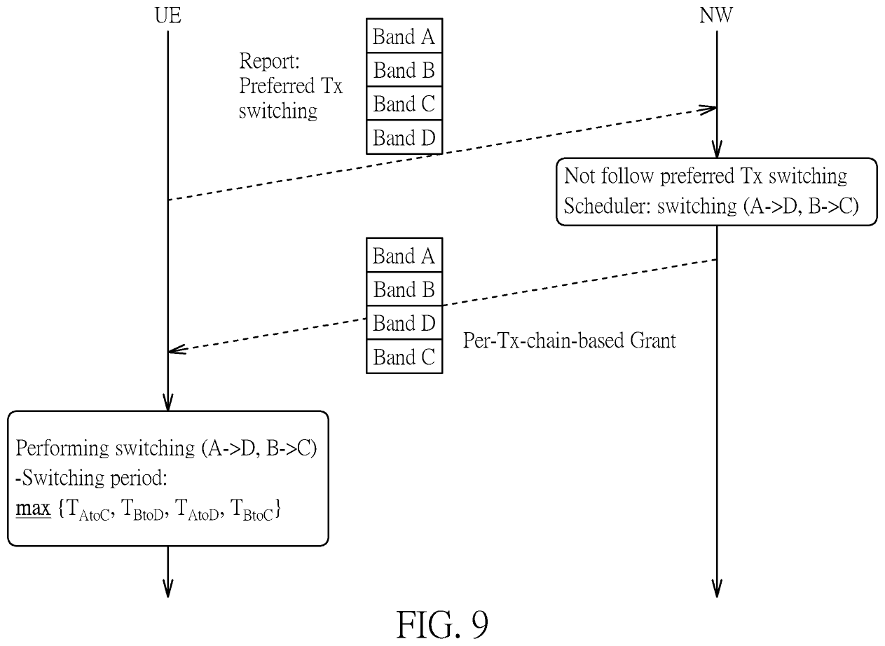

FIG. 9 is a sequence diagram illustrating interactions between an UE (e.g., 5G terminal) and a network NW (e.g., gNB of NG-RAN), both supporting the proposed band-ordering approach for implicitly signaling a Tx switching configuration, according to another embodiment of the present invention. By way of example, but not limitation, each of the UE (e.g., 5G terminal) and the NW (e.g., gNB of NG-RAN) may be implemented using the wireless communication device 100 shown in FIG. 1, where one of the signaling messages MSG1 and MSG2 may be used to indicate a preferred Tx switching configuration reported by the UE (e.g., 5G terminal), and the other of the signaling messages MSG1 and MSG2 may be a scheduled Tx switching configuration granted by the NW (e.g., NG-RAN of 5G system). The UE may report a preferred Tx switching configuration by the band-ordering approach if the preferred Tx switching configuration has an improved switching period (i.e., a shorter switching period) compared with the base line (e.g., max(T_{Atoc}, T_{BtoD}, T_{AtoD}, T_{BtoC}) where max(T_{Atoc}, T_{BtoD}) max(T_{Atoc}, T_{BtoD}, T_{AtoD}, T_{BtoC})=max(T_{AtoD},T_{BtoC}). Hence, the preferred Tx switching configuration is to replace Band A at Tx Chain #1 with Band C at Tx Chain #1 and replace Band B at Tx Chain #2 with Band D at Tx Chain #2. As shown in FIG. 9, the UE reports its preferred Tx switching configuration via “per-Tx-chain-based representation” for band combination (Band A, Band B, Band C, Band D).

In this example, NW schedules an uplink Tx switching different from UE's preferred uplink Tx switching, and sends a scheduled Tx switching configuration to UE via “per-Tx-chain-based representation” for band combination (Band A, Band B, Band C, Band D). That is, the scheduled Tx switching configuration is set by UE's non-preferred Tx switching configuration (which is to replace Band A at Tx Chain #1 with Band D at Tx Chain #1 and replace Band B at Tx Chain #2 with Band C at Tx Chain #2). As the preferred Tx switching configuration (which is to replace Band A at Tx Chain #1 with Band C at Tx Chain #1 and replace Band B at Tx Chain #2 with Band D at Tx Chain #2) is not granted by the network, a default switching period (i.e. max(T_{Atoc}, T_{BtoD}, T_{AtoD}, T_{BtoC})=max(T_{AtoD}, T_{Btoc})) is applied at the UE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for implicitly signaling a transmit (Tx) switching configuration, comprising:
configuring a first signaling message to indicate a band combination of a plurality of bands; and
sending the first signaling message, wherein the Tx switching configuration is implicitly signaled by an order of the plurality of bands of the band combination indicated by the first signaling message.

2. The method of claim 1, wherein the plurality of bands comprise at least a first band, a second band, a third band, and a fourth band; an order of the first band, the second band, the third band, and the fourth band in the band combination implicitly indicates that the first band is at a first Tx chain before switching, the second band is at a second Tx chain before switching, the third band is at the first Tx chain after switching, and the fourth band is at the second Tx chain after switching.

3. The method of claim 1, wherein the plurality of bands comprise at least a first band, a second band, a third band, and a fourth band; an order of the first band, the second band, the third band, and the fourth band in the band combination implicitly indicates that the first band and the second band are a band pair before switching, and the third band and the fourth band are a band pair after switching.

4. The method of claim 1, wherein the plurality of bands comprise at least a first band, a second band, a third band, and a fourth band; an order of the first band, the second band, the third band, and the fourth band in the band combination implicitly indicates that the first band and the third band are a switching pair at a first Tx chain, and the second band and fourth band are a switching pair at a second Tx chain.

5. The method of claim 1, wherein the first signaling message is a radio resource management (RRM) message.

6. The method of claim 1, wherein the first signaling message is a radio resource control (RRC) message.

7. The method of claim 1, wherein the method is employed by a user equipment (UE).

8. The method of claim 7, further comprising:
receiving a second signaling message from a base station (BS) of a radio access network (RAN), wherein the second signaling message indicates a band combination of the plurality of bands, and a scheduled Tx switching configuration set by the BS of the RAN is implicitly signaled by an order of the plurality of bands in the band combination indicated by the second signaling message.

9. The method of claim 8, wherein the UE receives the second signaling message from the BS after sending the first signaling message to the BS, and the scheduled Tx switching configuration implicitly signaled by the BS follows the Tx switching configuration implicitly signaled by the UE.

10. The method of claim 8, wherein the UE receives the second signaling message from the BS after sending the first signaling message to the BS, and the scheduled Tx switching configuration implicitly signaled by the BS does not follow the Tx switching configuration implicitly signaled by the UE.

11. The method of claim 1, wherein the method is employed by a base station of a radio access network (RAN).

12. The method of claim 11, further comprising:
receiving a second signaling message from a user equipment (UE), wherein the second signaling message indicates a band combination of the plurality of bands, and a preferred Tx switching configuration reported by the UE is implicitly signaled by an order of the plurality of bands in the band combination indicated by the second signaling message.

13. The method of claim 12, wherein the BS receives the second signaling message from the UE before sending the first signaling message to the UE, and the Tx switching configuration implicitly signaled by the BS follows the preferred Tx switching configuration implicitly signaled by the UE.

14. The method of claim 12, wherein the BS receives the second signaling message from the UE before sending the first signaling message to the UE, and the scheduled Tx switching configuration implicitly signaled by the BS does not follow the Tx switching configuration implicitly signaled by the UE.

15. A wireless communication device that supports implicitly signaling of a transmit (Tx) switching configuration, comprising:
a wireless communication circuit; and
a control circuit, arranged to configure a first signaling message to indicate a band combination of a plurality of bands, and instruct the wireless communication circuit to send the first signaling message, wherein the Tx switching configuration is implicitly signaled by an order of the plurality of bands of the band combination indicated by the first signaling message.

16. The wireless communication device of claim 15, wherein the plurality of bands comprise at least a first band, a second band, a third band, and a fourth band; an order of the first band, the second band, the third band, and the fourth band in the band combination implicitly indicates that the first band is at a first Tx chain before switching, the second band is at a second Tx chain before switching, the third band is at the first Tx chain after switching, and the fourth band is at the second Tx chain after switching.

17. The wireless communication device of claim 15, wherein the plurality of bands comprise at least a first band, a second band, a third band, and a fourth band; an order of the first band, the second band, the third band, and the fourth band in the band combination implicitly indicates that the first band and the second band are a band pair before switching, and the third band and the fourth band are a band pair after switching.

18. The wireless communication device of claim 15, wherein the plurality of bands comprise at least a first band, a second band, a third band, and a fourth band; an order of the first band, the second band, the third band, and the fourth band in the band combination implicitly indicates that the first band and the third band are a switching pair at a first Tx chain, and the second band and fourth band are a switching pair at a second Tx chain.

19. The wireless communication device of claim 15, wherein the first signaling message is a radio resource management (RRM) message.

20. The wireless communication device of claim 15, wherein the first signaling message is a radio resource control (RRC) message.

21. The wireless communication device of claim 15, wherein the wireless communication device is a user equipment (UE).

22. The wireless communication device of claim 21, wherein the wireless communication circuit is further arranged to receive a second signaling message from a base station (BS) of a radio access network (RAN), the second signaling message indicates a band combination of the plurality of bands, and a scheduled Tx switching configuration set by the BS of the RAN is implicitly signaled by an order of the plurality of bands in the band combination indicated by the second signaling message.

23. The wireless communication device of claim 22, wherein the UE receives the second signaling message from the BS after sending the first signaling message to the BS, and the scheduled Tx switching configuration implicitly signaled by the BS follows the Tx switching configuration implicitly signaled by the UE.

24. The wireless communication device of claim 22, wherein the UE receives the second signaling message from the BS after sending the first signaling message to the BS, and the scheduled Tx switching configuration implicitly signaled by the BS does not follow the Tx switching configuration implicitly signaled by the UE.

25. The wireless communication device of claim 15, wherein the wireless communication device is a base station of a radio access network (RAN).

26. The wireless communication device of claim 25, wherein the wireless communication device is further arranged to receive a second signaling message from a user equipment (UE), the second signaling message indicates a band combination of the plurality of bands, and a preferred Tx switching configuration reported by the UE is implicitly signaled by an order of the plurality of bands in the band combination indicated by the second signaling message.

27. The wireless communication device of claim 26, wherein the BS receives the second signaling message from the UE before sending the first signaling message to the UE, and the Tx switching configuration implicitly signaled by the BS follows the preferred Tx switching configuration implicitly signaled by the UE.

28. The wireless communication device of claim 26, wherein the BS receives the second signaling message from the UE before sending the first signaling message to the UE, and the Tx switching configuration implicitly signaled by the BS does not follow the preferred Tx switching configuration implicitly signaled by the UE.
